(19) United States
(12) Patent Application Publication
(10) Pub. No.: US 2025/0107658 A1
(43) Pub. Date: Apr. 3, 2025

(54) METHOD AND APPARATUS FOR VENTING A COOKING APPARATUS

(71) Applicant: Midea Group Co., Ltd., Beijiao (CN)

(72) Inventors: Daniel J. Trice, Louisville, KY (US); Brian M. Langness, Shelbyville, KY (US); Felicity Peebles, Wetumpka, AL (US)

(21) Appl. No.: 18/477,431

(22) Filed: Sep. 28, 2023

(51) Int. Cl. A47J 37/07

(52) U.S. Cl. CPC A47J 37/0786; A47J 37/0704

(57) ABSTRACT

A method and apparatus for venting a cooking apparatus. A cooking apparatus may have one or more vents and/or vent openings. The cooking apparatus may include one or more actuators for venting. The cooking apparatus may include a lid. The lid may include one or more vents and/or vent openings. The one or more vents and/or lid may be positionable between a closed position and an open position.

### BACKGROUND

The present embodiments relate to a method and apparatus for venting a cooking appliance, more specifically a lid for a cooking appliance.

Typical appliances (e.g. grill, smoker, barbeque, outdoor, indoor) may trap/build up and subsequently release heat, heated air, and/or smoke in the direction of the user when opening the door/lid. Thus, there is a need to reduce and/or redirect the heat/smoke/air from expelling directly towards the user when operating the door/lid.

### SUMMARY

In some embodiments, an appliance may have a cooking cavity. In various embodiments, the appliance may include a housing having the cooking cavity. In some embodiments, at least a portion of the housing may define one or more openings into the cooking cavity. In some embodiments, the appliance may include a lid hingedly attached adjacent the opening into the cooking cavity of the housing. In various embodiments, the lid may be positionable between a closed position and an open position relative to the opening into the cooking cavity. In some embodiments, the lid may define at least one vent opening. In various embodiments, the lid may include one or more vents and/or one or more handles. In some embodiments, the one or more vents may be moveable between a closed position closing at least one vent opening to define a portion of the cooking cavity and an open position different from the closed position. In various embodiments, the one or more handles may actuate the one or more vents between the closed position and the open position.

In addition, in some embodiments, the one or more handles may actuate the one or more vents when the lid is in the closed position. In various embodiments, at least a portion of the one or more handles may be in a first position when the one or more vents may be in the closed position and a second position when the one or more vents may be in the open position. In some embodiments, in the first position at least a portion of the one or more handles may be proximate to the lid and wherein in the second position at least a portion of the one or more handles may be distal away from the lid. In various embodiments, in the first position at least a portion of the one or more handles may be distal away from the lid and wherein in the second position at least a portion of the one or more handles may be proximate to the lid. In some embodiments, at least one portion of the one or more handles linearly translates between the first position and the second position. In various embodiments, the one or more vents may be adjacent a rear wall of the lid and the one or more handles may be adjacent a front wall of the lid. In some embodiments, the appliance may include an articulating assembly between the one or more vents and the one or more handles. In some embodiments, the articulating assembly may include one or more linkage members and/or one or more cams between the one or more vents and the one or more handles.

In some embodiments, a lid may be hingedly attached to an appliance and positionable between a closed position and an open position. In various embodiments, the lid may include one or more vents positionable between a closed position closing one or more vent openings defined by at least a portion of the lid and an open position opening the one or more vent openings defined by at least the portion the lid. In some embodiments, the lid may include one or more handles connected to the lid. In various embodiments, the one or more handles may actuate the one or more vents between the closed position and the open position.

In addition, in some embodiments, the lid may include one or more articulating assemblies between the one or more vents and the one or more handles. In various embodiments, the articulating assembly may include one or more linkage members and/or one or more cams between the one or more vents and the one or more handles. In some embodiments, the one or more vents may pivot about a hinge relative to the lid. In various embodiments, the one or more vents may be positioned on a top wall of lid and/or the one or more handles are positioned on a front wall of the lid. In some embodiments, the one or more handles may actuate the one or more vents between the closed position and the open position by at least one of pushing and/or pulling the one or more handles relative to the lid. In various embodiments, the lid may be in combination with an outdoor appliance. In some embodiments, the outdoor appliance may be a grill. In various embodiments, the lid may be positionable between an open position and a closed position, wherein the one or more vents may be actuated when the lid is in at least one of the open position and/or the closed position.

In some embodiments, a method of articulating one or more vents of a cooking appliance may include providing a housing having a cooking cavity defining an opening into the cooking cavity and a lid hingedly attached adjacent the opening into the cooking cavity of the housing. In various embodiments, the lid may be positionable between a closed position and an open position relative to the opening into the cooking cavity. In some embodiments, the lid may include one or more vents positionable between a closed position closing at least one vent opening and an open position different from the closed position. In various embodiments, the method may include actuating one or more handles of the lid to position the one or more vents between the closed position and the open position when the lid may be in at least the closed position.

In addition, in some embodiments, the method may include pivoting the one or more vents relative to the lid between the closed position and the open position. In various embodiments, the method may include venting the cooking cavity before opening the lid to the open position. In some embodiments, the method of actuating the one or more handles may include pushing at least a portion of the one or more handles relative to the lid. In various embodiments, the method of actuating the one or more handles may include pulling at least a portion of the one or more handles relative to the lid. In some embodiments, the method of actuating the one or more handles may deploy the one or more vents away from the at least one vent opening to the open position. In various embodiments, the method of actuating the handle may include the step of sliding the handle relative to the lid.

In some embodiments, an appliance may have a cooking cavity. In various embodiments, the appliance may include a housing having the cooking cavity. In some embodiments, the housing may define an opening into the cooking cavity. In various embodiments, the appliance may include a lid hingedly attached adjacent the opening into the cooking cavity to the housing. In some embodiments, the lid may be positionable between a closed position and an open position relative to the opening into the cooking cavity. In various embodiments, the lid may define at least one vent opening. In some embodiments, the lid may include one or more vents. In various embodiments, the one or more vents may be moveable between a closed position closing the at least one vent opening to define a portion of the cooking cavity and an open position different from the closed position. In some embodiments, the lid may actuate the one or more vents between the closed position and the open position.

In addition, in some embodiments, when the lid moves from the closed position to the open position, the one or more vents may move from the closed position to the open position. In various embodiments, when the lid moves from the open position to the closed position, the one or more vents may move from the open position to the closed position. In some embodiments, the one or more vents may be adjacent a rear wall and/or top wall of the lid. In various embodiments, the appliance may include an articulating assembly connected to the one or more vents of the lid. In some embodiments, the articulating assembly may include one or more linkage members and/or at least one biased plunger connected to the one or more vents. In various embodiments, the articulating assembly may include at least one biased plunger. In some embodiments, the appliance may include a bias mechanism urging the one or more vents to the open position.

In some embodiments, a lid may be hingedly attached to an appliance and positionable between a closed position and an open position. In various embodiments, the lid may include one or more vents positionable between a closed position closing one or more vent openings defined by at least a portion of the lid when the lid is in the closed position and an open position opening the one or more vent openings defined by at least the portion the lid when the lid is in the open position. In some embodiments, one or more bias mechanisms may urge the one or more vents to the open position.

In addition, in some embodiments, the lid may actuate one or more vents between the closed position and the open position. In various embodiments, when the lid moves from the closed position to the open position, the one or more vents may move from the closed position to the open position. In some embodiments, the bias mechanism may include at least one biased plunger. In various embodiments, the bias mechanism may be connected to one or more vents via one or more linkage members. In some embodiments, the one or more vents may include a first wall and one or more depending walls extending from the first wall.

In some embodiments, a method of articulating one or more vents of a cooking appliance may include providing a housing having a cooking cavity defining an opening into the cooking cavity and a lid hingedly attached adjacent the opening into the cooking cavity to the housing. In various embodiments, the lid may be positionable between a closed position and an open position relative to the opening into the cooking cavity. In some embodiments, the lid may include one or more vents positionable between a closed position closing at least one vent opening and an open position different from the closed position. In various embodiments, the method may include actuating the lid from the closed position to the open position to position the one or more vents from the closed position to the open position.

In addition, in some embodiments, the method may include biasing the one or more vents towards the open position. In various embodiments, the method may include pivoting the one or more vents relative to the lid between the closed position and the open position. In some embodiments, the method may include actuating the lid from the open position to the closed position to position the one or more vents from the open position to the closed position. In various embodiments, the method may include pivoting the lid between the closed position and the open position. In some embodiments, the method may include depressing a biased plunger when the lid is in the closed position.

In some embodiments, an appliance may have a cooking cavity. In various embodiments, the appliance may include a housing having the cooking cavity and/or defining an opening into the cooking cavity. In some embodiments, the housing may include one or more tracks. In various embodiments, the housing and/or appliance may include one or more lids adjacent the opening into the cooking cavity to the housing. In some embodiments, the one or more lids may be positionable between a closed position and an open position relative to the opening into the cooking cavity. In various embodiments, the one or more lids may include one or more followers. In some embodiments, the one or more followers may engage the one or more tracks to guide the one or more followers and/or the one or more lids between the closed position and the open position.

In addition, in some embodiments, one or more side walls of the housing may include the one or more tracks. In various embodiments, the housing may include a top wall and depending side walls, wherein the one or more lids may engage the top wall when in the closed position and may disengage from the top wall when in the open position. In some embodiments, the one or more lids may include a flange overlapping the top wall when the one or more lids are in the closed position. In various embodiments, the one or more lids may include an outer periphery, wherein when the one or more lids are in the closed position the entire outer periphery of the one or more lids may be adjacent the housing defining the opening and when the one or more lids are in the open position the entire outer periphery of the one or more lids may be spaced from the housing defining the opening. In some embodiments, the one or more followers may include at least one member and/or at least one pin. In various embodiments, at least one pin may be on a distal end of at least one member away from the one or more lids. In some embodiments, at least one pin may slidably engage the one or more tracks. In some embodiments, the one or more followers may be fixed relative to the one or more lids. In various embodiments, a top wall of the one or more lids may travel upwardly and/or towards the user when moved away from the closed position towards the open position. In some embodiments, the appliance may be an outdoor grill.

In some embodiments, an appliance may have a cooking cavity. In various embodiments, the appliance may include a housing having the cooking cavity and/or defining an opening into the cooking cavity. In some embodiments, the housing may include a top wall. In some embodiments, the housing may include a rear wall depending from the top wall. In some embodiments, the housing may include opposing side walls depending from the top wall. In various embodiments, the appliance may include a self-venting lid defining a vent opening with the top wall of the housing. In some embodiments, the lid may be moveable between a closed position and an open position relative to the opening into the cooking cavity. In various embodiments, when the lid is in the closed position the vent opening may be closed between the lid and the top wall of the housing. In some embodiments, when the lid is in the open position the vent opening between the lid and the top wall of the housing may be open.

In addition, in some embodiments, the appliance may include one or more followers slidably engaging one or more tracks to guide the lid between the closed position and the open position. In various embodiments, the housing may include one or more tracks and the lid may include one or more followers. In some embodiments, the one or more tracks may be non-linear. In various embodiments, a top wall of the lid may travel upwardly and/or towards the user when moved away from the closed position towards the open position. In some embodiments, the lid may include a flange overlapping the top wall when the lid is in the closed position.

In some embodiments, a method of self-venting a cooking appliance may include providing a cooking appliance having a top side. In various embodiments, the top side may include a top wall of a housing and at least a portion a lid. In some embodiments, the method may include actuating the lid relative to the housing from a closed position to an open position to manipulate an opening to a cooking cavity. In various embodiments, the method may include upwardly venting from the top side of the appliance between the top wall of the housing and the portion of the lid when opening the lid.

In addition, in some embodiments, the method may include slidably engaging the lid relative to the housing between the closed position and the open position. In various embodiments, the method may include sliding the lid relative to the housing in a non-linear path. In some embodiments, the cooking appliance may include one or more followers slidably engaging one or more tracks between the housing and the lid. In various embodiments, a rear portion of the lid may include a first set of the one or more followers slidably engaging the one or more tracks between the housing and the lid and a front portion of the lid may include a second set of the one or more followers slidably engaging the one or more tracks between the housing and the lid.

These and other advantages and features, which characterize the embodiments, are set forth in the claims annexed hereto and form a further part hereof. However, for a better understanding of the embodiments, and of the advantages and objectives attained through its use, reference should be made to the Drawings and to the accompanying descriptive matter, in which there is described example embodiments. This summary is merely provided to introduce a selection of concepts that are further described below in the detailed description, and is not intended to identify key or essential features of the claimed subject matter, nor is it intended to be used in limiting the scope of the claimed subject matter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a perspective view of one embodiment of an appliance or an outdoor grill, with portions of the appliance broken away illustrating the lid in a closed position, the lid handle and/or articulating assembly in a first position, and a vent in a closed position;

FIG. 2 is a perspective view of the embodiment of the lid of FIG. 1;

FIG. 3 is a perspective view of the embodiment of the appliance of FIG. 1, with portions of the appliance broken away illustrating the lid in the closed position, the lid handle and/or articulating assembly in a second position, and a vent in an open position, and illustrating at least a portion of the handle being pushed by the user;

FIG. 4 is a perspective view of the embodiment of the lid of FIG. 3;

FIG. 5 is a perspective view of one embodiment of an appliance or an outdoor grill, with portions of the appliance broken away illustrating the lid in a closed position, the lid handle and/or articulating assembly in a first position, and a vent in a closed position;

FIG. 6 is a perspective view of the embodiment of the lid of FIG. 5;

FIG. 7 is a perspective view of the embodiment of the appliance of FIG. 5, with portions of the appliance broken away illustrating the lid in the closed position, the lid handle and/or articulating assembly in a second position, and a vent in an open position, and illustrating at least a portion of the handle being pulled by the user;

FIG. 8 is a perspective view of the embodiment of the lid of FIG. 7;

FIG. 9 is a perspective view of one embodiment of an appliance or an outdoor grill, with portions of the appliance broken away illustrating the lid in a closed position, the articulating assembly in a first position, and a vent in a closed position;

FIG. 10 is a perspective view of the embodiment of the lid of FIG. 9;

FIG. 11 is a perspective view of the embodiment of the appliance of FIG. 9, with portions of the appliance broken away illustrating the lid in the open position, the articulating assembly in a second position, and a vent in an open position;

FIG. 12 is a perspective view of the embodiment of the lid of FIG. 11;

FIG. 13 is a perspective view of one embodiment of an appliance or an outdoor grill, illustrating the lid in a closed position and a vent opening(s) in a closed position;

FIG. 14 is a sectional view of the appliance embodiment taken along line 14-14 of FIG. 13;

FIG. 15 is a sectional view of the appliance embodiment taken along line 14-14 of FIG. 13, illustrating the progressive opening of the lid away from the position shown in FIG. 14 and the vent opening(s) in an open position;

FIG. 16 is a sectional view of the appliance embodiment taken along line 14-14 of FIG. 13, illustrating the progressive opening of the lid away from the position shown in FIG. 15 and the vent opening(s) in an open position;

FIG. 17 is a sectional view of the appliance embodiment taken along line 14-14 of FIG. 13, illustrating the progressive opening of the lid away from the position shown in FIG. 16 and the vent opening(s) in an open position;

FIG. 18 is a sectional view of the appliance embodiment taken along line 14-14 of FIG. 13, illustrating the progressive opening of the lid away from the position shown in FIG. 17 or a fully open position, and the vent opening(s) in an open position;

FIG. 19 is a perspective view of the appliance embodiment shown in FIG. 18.

### DETAILED DESCRIPTION

Numerous variations and modifications will be apparent to one of ordinary skill in the art, as will become apparent from the description below. Therefore, the invention is not limited to the specific implementations discussed herein.

The embodiments discussed hereinafter will focus on the implementation of the hereinafter-described techniques and apparatuses within a cooking appliance (e.g. outdoor, indoor) such as, but is not limited to a grill 10, such as the type that may be used in single-family or multi-family dwellings, outdoor, restaurants, or in other similar applications. However, it will be appreciated that the herein-described techniques and apparatuses may also be used in connection with other types of cooking/baking/grilling/smoking appliances in some embodiments. For example, the herein-described techniques may be used in commercial applications in some embodiments. Moreover, the herein-described techniques may be used in connection with various cooking appliance configurations that would be well within the abilities of one of ordinary skill in the art having the benefit of the instant disclosure, so the embodiments are not limited to the grill/outdoor appliance implementation discussed further herein. For example, the cooking appliance may be used indoor and/or be a countertop appliance.

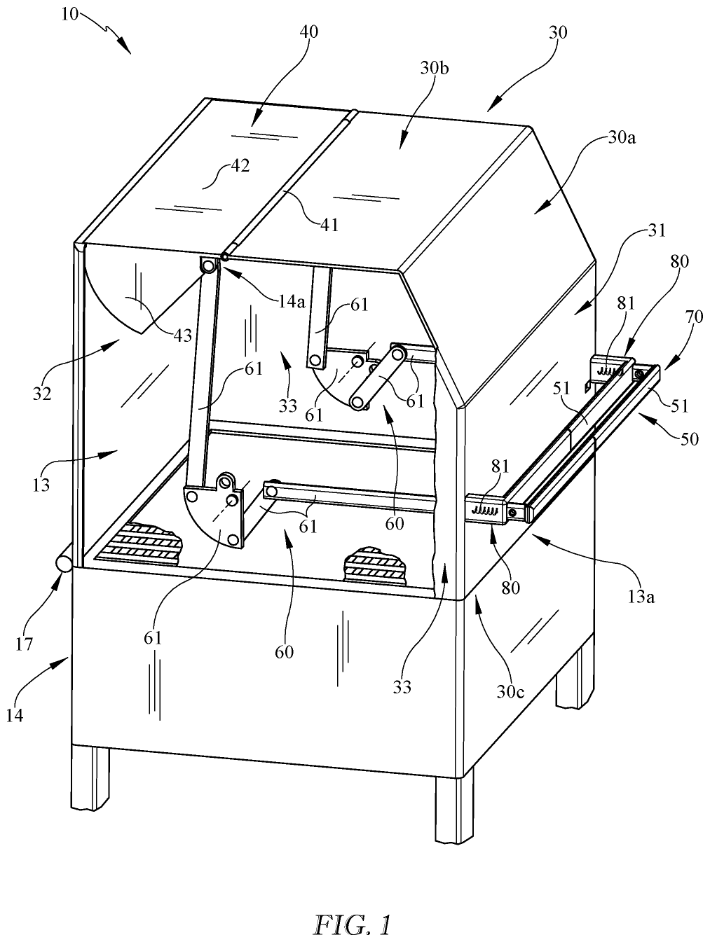

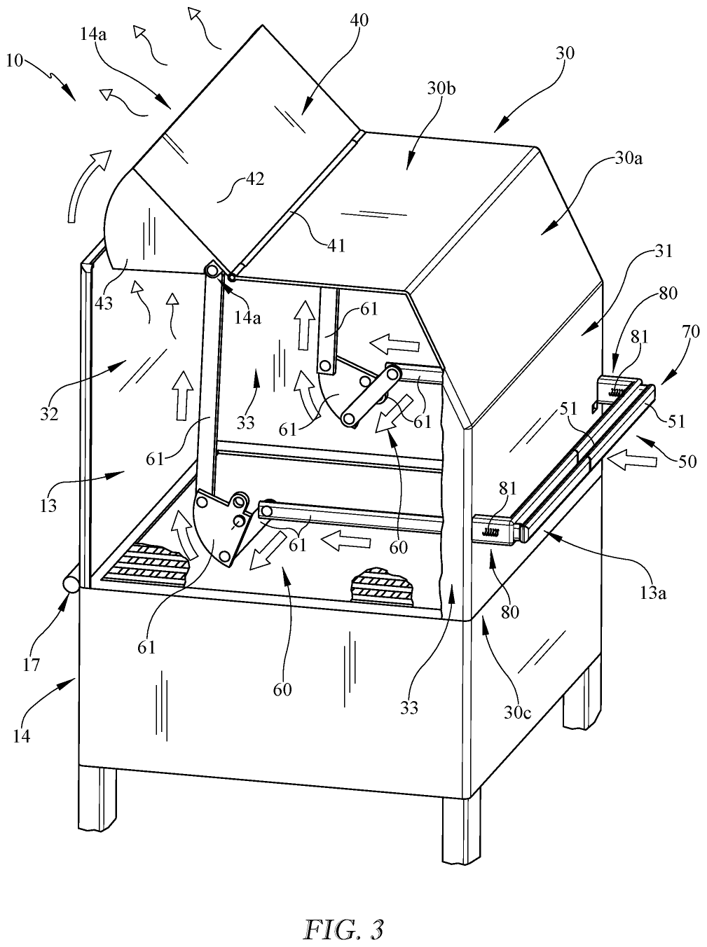

Turning now to the drawings, the Figures illustrate an example cooking appliance 10 in which the various technologies and techniques described herein may be implemented. Cooking appliance 10 is depicted in this example as an outdoor grill (e.g. barrel), and as such includes a lid/door 30 in a cabinet or housing 14 that provides access to the cooking cavity/compartment 13 housed within the cabinet or housing 14, and when in the open position (FIGS. 3, 4, 7, 8, 11, and 12), food or items (e.g. trays, utensils, grills, racks, accessories, etc.) may be inserted into, manipulated, and/or removed from the cooking cavity 13. The housing 14/lid 30 may define at least a portion of an opening 13a into the cooking cavity 13. The opening 13a may be between the upper edge of the lower housing and the lid 30. The opening 13a may be closed when the lid 30 is in the closed position and open when the lid 30 is in the open position. Lid/door 30 may be pivotably/hingedly attached to the housing 14 (e.g. remaining portion) adjacent the cooking cavity 13 and/or vent opening 14a. The lid 30 may be a top lid as shown in the one embodiment. Lid 30 may be generally provided with a hinge 17 along a corresponding side or rear edge of the housing 14 adjacent the cooking cavity 13 and is pivotable/positionable between a closed position (FIGS. 1, 2, 5, 6, 9, and 10) and an open position (FIGS. 3, 4, 7, 8, 11, and 12). The lid 30 or body 30a may include a top surface/wall 30b and an opposing bottom edge/side 30c adjacent the hinge 17 configured to engage the appliance 10/housing 14. The lid 30 may be hinged or pivot about a horizontal axis or hinge. The lid 30 or body 30a may include a front surface/wall 31 and opposing rear surface/wall 32 interconnected by side surfaces/walls 33 interconnecting the top surface/wall 30b to the bottom edge 30c. When lid 30 is in the open position, food and items may be inserted into, manipulated, and/or removed from the cooking cavity 13 through the opening 13a defined by the lid/housing. Moreover, when the lid/door 30 is in at least one position or range of positions (e.g. open, closed, first position, second position . . . , fourth position, etc.), one or more vents 40 may be deployed/positioned/stowed (e.g. open, closed) relative to the cooking cavity 13/vent opening 14a/lid 30/housing 14. It should be understood that the lid, vent, vent openings, and/or housing may be a variety of shapes, sizes, quantities, positions, and constructions and still be within the scope of the invention. For example, the door/lid may slide relative to the opening rather than pivot as is shown in the one embodiment.

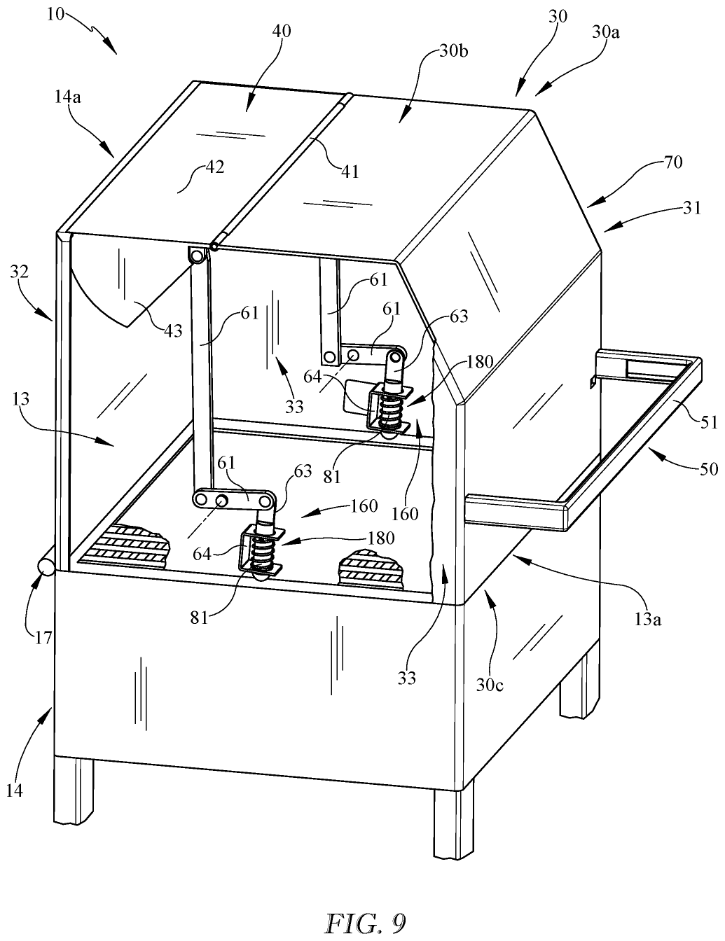

In some implementations, one or more vents 40 may be actuated between closed and open positions relative to appliance 10, vent openings 14a, and/or lid 30. The vents 40 may be pivotable/positionable between the closed position and the open position. Opening/closing the vent(s) 40 relative to the appliance 10, or portions thereof, may change one or more properties of the appliance 10 or cooking cavity 13, internally and/or externally. Opening/deploying the one or more vents 40 may redirect or direct appliance or cooking cavity properties (e.g. heat/smoke/fumes/air/grease/temperature) through the vent opening/channel 14a away from the user before opening/closing and/or when opening/closing the lid/door relative to the housing 14 (e.g. remaining, vent opening). The one or more vents 40 (e.g. before opening/closing and/or during opening/closing) may be operated by the user, the actuator(s), and/or automatically for a variety of durations/periods and/or at a variety of occurrences (e.g. one or more times) during operation of the apparatus. One or more actuators/devices 70 and techniques may be used to actuate the vent(s) 40. For example, in some embodiments, the actuator 70 may be one or more handles 50 of the lid/door 30. The handle(s) may assist the user to operate the lid/door and/or operate/actuate the one or more vents as shown in the one embodiment in FIGS. 1-8. In various embodiments, the actuator 70 may be the operation of the one or more doors/lids 30. The lid(s) 30 operation may operate/actuate the one or more vents 40 as shown in the one embodiment in FIGS. 9-12. The one or more vents 40 may be actuated manually separate from the lid operation (e.g. FIGS. 1-8) and/or automatically with the lid operation (e.g. FIGS. 9-12). In some implementations, the user may desire when not to and/or when to operate the vent(s) of the apparatus (e.g. during operation, closing, opening, closed, open, both open and closed, etc.).

In some implementations, the appliance 10, housing 14, and/or lid 30 may include or define one or more vent openings 14a and/or vents 40. The vent 40 may positioned away from the opening 13a and/or adjacent a rear of the appliance 10. The one or more vents 40/vent openings 14a may be positioned in and/or adjacent the top surface/wall 30b and/or rear surface/wall 32 of the body 30a as shown in the one embodiment, however a variety of positions may be used and still be within the scope of the invention. The one or more vents 40/vent openings 14a may be positioned opposite or distal from the handle(s) 50 and/or front surface/wall 31. The one or more vents 40/vent openings 14a may be positioned between the side surfaces/walls 33. One or more portions of the lid 30/housing 14/vent 40 may define one or more portions of the vent opening 14a. The vent opening 14a and/or vent 40 may be of a variety of shapes, sizes, quantities, positions, and constructions and still be within the scope of the invention.

In some implementations, one or more vents 40 may be moveable/reconfigurable between a closed/first position (e.g. pivot) and one or more open/second positions (e.g. pivot) different from the closed position. In the closed position as shown in FIGS. 1, 2, 5, 6, 9, and 10, the one or more vents 40 may define at least a portion of the lid 30/cooking cavity 13/housing 14. In the closed position, the one or more vents 40 may close the vent opening 14a (e.g. not allow gases/materials to exit the vent opening). The size or channel of the vent opening in the closed position of the vent may be less than or fully closed than when the vent in the open position. In the open position as shown in FIGS. 3, 4, 7, 8, 11, and 12, the one or more vents 40 may open the vent opening 14a (e.g. increase flow channel, allow gas/materials to exit the vent opening). The vented or directed gases may be directed in direction away from the front/opening of the appliance and/or the user. The gas may be vented behind the appliance 10 and/or in the rear/lateral directions. The one or more vents 40 may pivot or be hinged (e.g. hinge 41, hinge/pivot axis) to the lid 30/appliance 10 as shown in the one embodiment, however a variety of connections may be used. For example, the vent 40, or portions thereof, may slide/roll/rotate relative to the lid 30 in a variety of orientations/directions/paths/distances. The hinge 41 may be proximal the user or front surface/wall 31 of the lid 30/appliance 10 and/or engage the top surface/wall 30b. The distal free edge of the first wall of the vent may be opposite to the hinge 41. The distal free edge may be distal from the user or front surface/wall 31. The hinge 41 may be horizontal and/or parallel to the user/front and/or lid hinge 17 in the one embodiment, however the hinge 41 may be in a variety of orientations/positions. The vent 40 may pivot a variety of angles and/or move a variety of distances relative to the lid/appliance. The user may pivot the vent for a variety of angles. In the vent closed position, the angle relative to the top wall 30b may be 180 degrees and when in the open position the vent open position may be less than 180 degrees. The pivot of the vent 40 may be a portion of the range of pivoting the vent 40 can travel. For example, the user may pivot/move the vent 40 for a portion of the available pivot angle and/or distance or not the full angle/distance/range of the vent relative to the vent opening 14a and/or wall(s). In other embodiments, the user may pivot/move the full pivot/distance range of the vent 40. The user/actuator 70 may adjust the size of the channel or vent opening 14a and/or amount/speed of fluid/gas that is vented in some embodiments. The vent 40 may open the flow path/channel in a direction opposite to or away from the user or front of the appliance 10 (e.g. front surface/wall). The vent 40 may pivot from the rear towards the front of the appliance 10 as shown in the one embodiment, however the vent may pivot or move in a variety of directions and direct gases, etc. towards a variety of directions away from the user/front, not limited to direction opposite from the user. For example, the direction may be lateral/down and/or away from a user and/or object adjacent the appliance. In the one embodiment shown, the vent 40 may be a first wall 42 and one or more depending walls 43. The depending walls 43 may project or extend from the first wall 42 or edges thereof. The first wall 42 may be parallel to the top surface/wall 30b when the vent 40 is in the closed position. The first wall 42 may be angled or pivoted to the top surface/wall 30b when the vent 40 is in the open position. The one or more depending walls 43 may be adjacent opposing lateral sides of the first wall 42 and/or extend perpendicular to the hinge 41. The lateral sides 43 may be stowed in the closed position of the vent 40 and deployed in the open position of the vent. The side walls may have a curved edge opposite the hinge or hinged edge of the first wall. The side walls may define a portion of the channel or vent opening when the vent is in the open position.

In some implementations, the appliance 10, lid 30, and/or vent 40 may include one or more articulating assemblies 60, 160. The articulating assembly 60, 160 may interconnect to the one or more vents 40 to move the vents between one or more positions. The articulating assembly 60, 160 may include one or more linkage members 61, one or more cams (not shown), brackets 64, and/or one or more plungers 63 (e.g. biased) as shown in the one embodiment, however other devices may be used. For example, one or more pivot pins (e.g. moveable, stationary) may be used between linkage members and/or appliance 10 (e.g. lid). The articulating assembly 60, 160 may interact or connect (e.g. operable engage) the vent(s) 40 to one or more portions of the appliance 10 (e.g. actuators 70, lid 30) to move the vent 40 between vent positions. The articulating assembly 60 (e.g. linkage member(s), cam, etc.) may be between or connect/interact (e.g. operable engage) the one or more vents 40 to one or more handles 50/actuator 70/lid 30 as shown in the one embodiment in FIGS. 1-8. The articulating assembly 160 may be between or connect/interact (e.g. operable engage) the one or more vents 40 with one or more portions of the appliance 10/lid 30/housing 14/actuator 70 as shown in the one embodiment in FIGS. 9-12. The articulating assembly 60, 160 may be of a variety of shapes, sizes, quantities, positions, and constructions. For example, the vent/actuator/appliance may include two articulating assemblies attached to the vent, actuator, and/or one or more portions of the appliance as shown in the one embodiment, however a single articulating assembly may be used. The articulating assembly may be positioned in a variety of positions within the appliance/housing. As shown in the embodiments, the articulating assembly 60, 160 may be positioned within the housing/lid. The articulating assembly may be positioned adjacent the one or more side walls 33 (e.g. interior, exterior) of the lid 30. It should be understood that the articulating assembly and/or actuator may be a variety of constructions, shapes, sizes, quantities, and positions and still be within the scope of the invention.

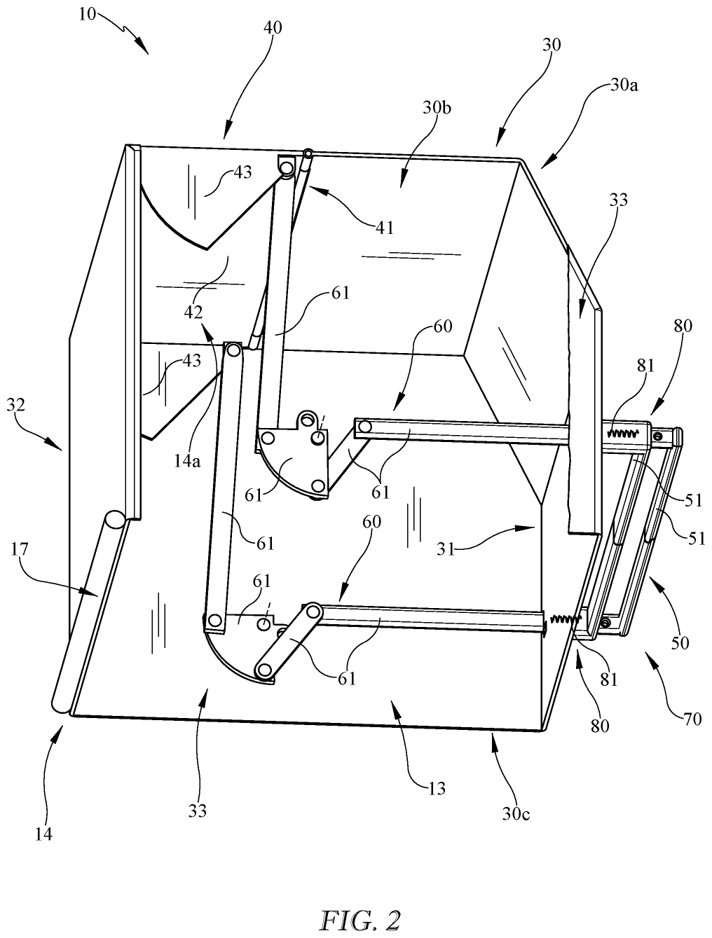

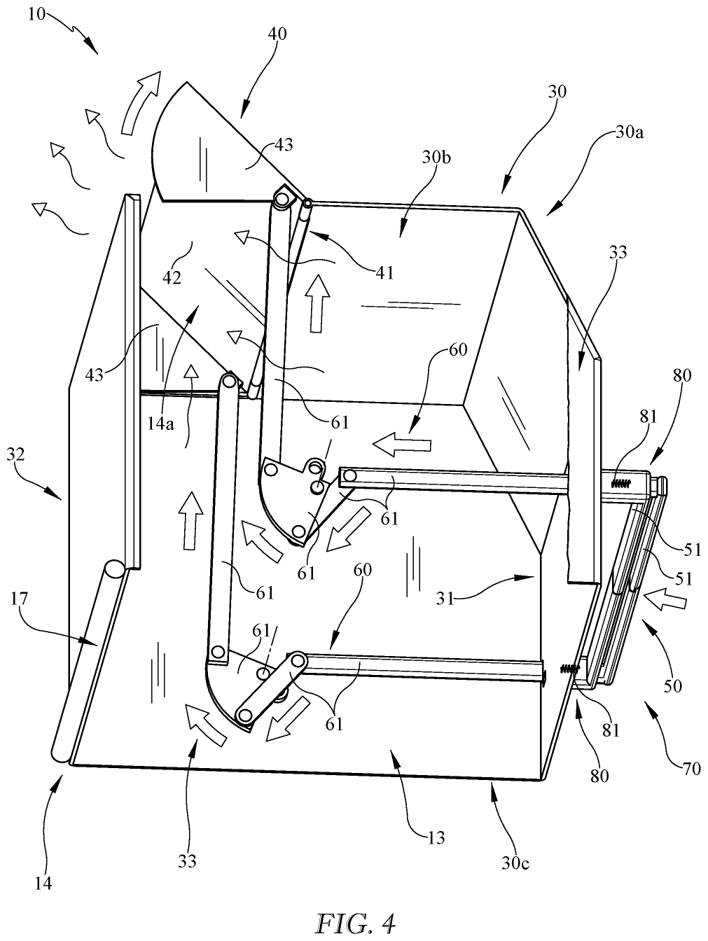

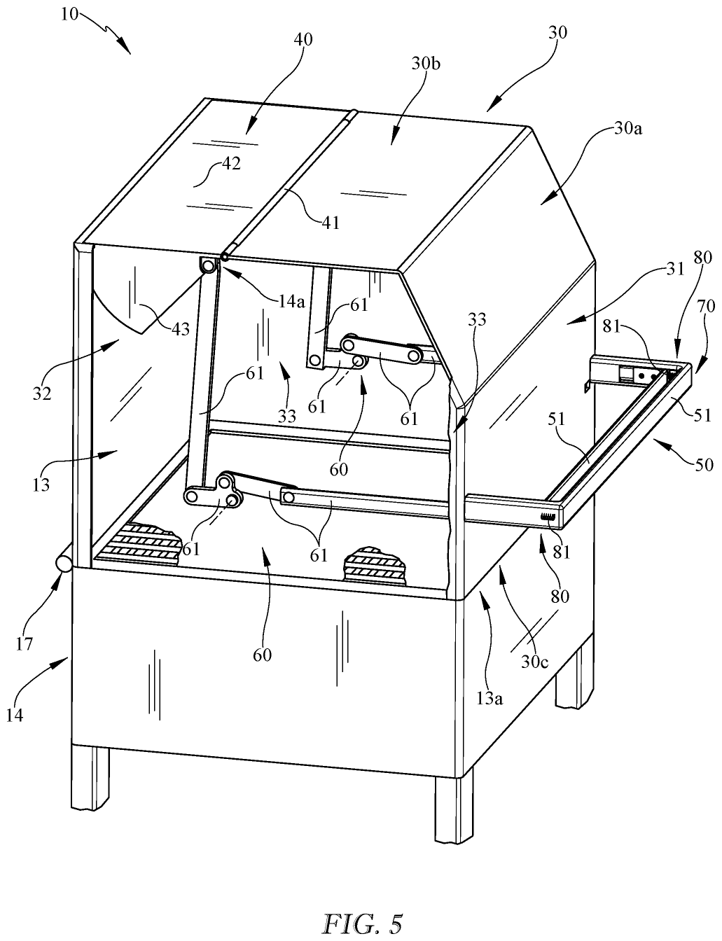

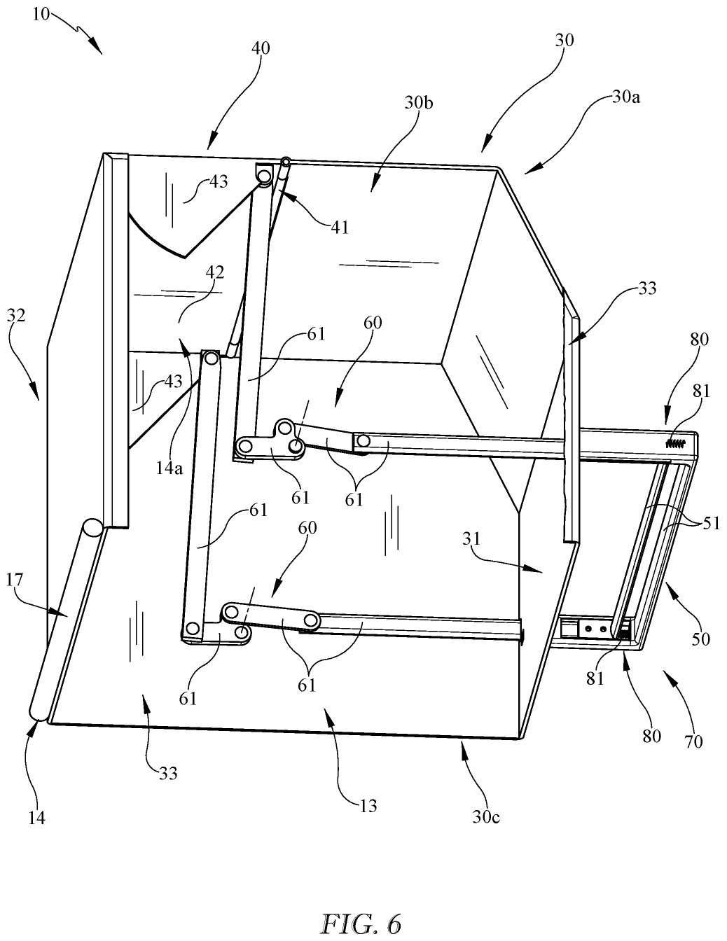

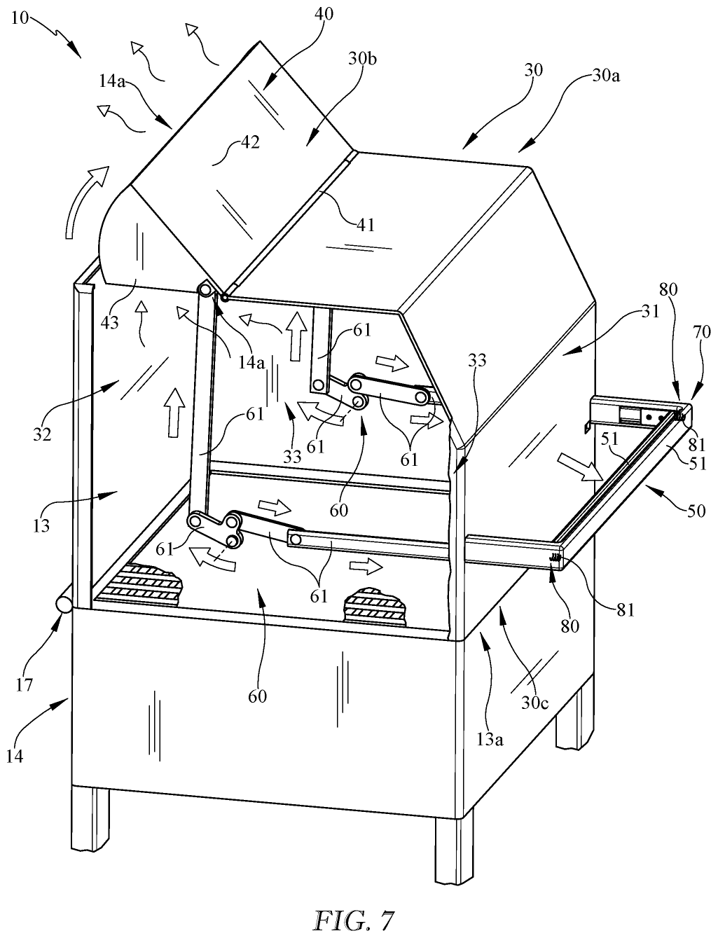

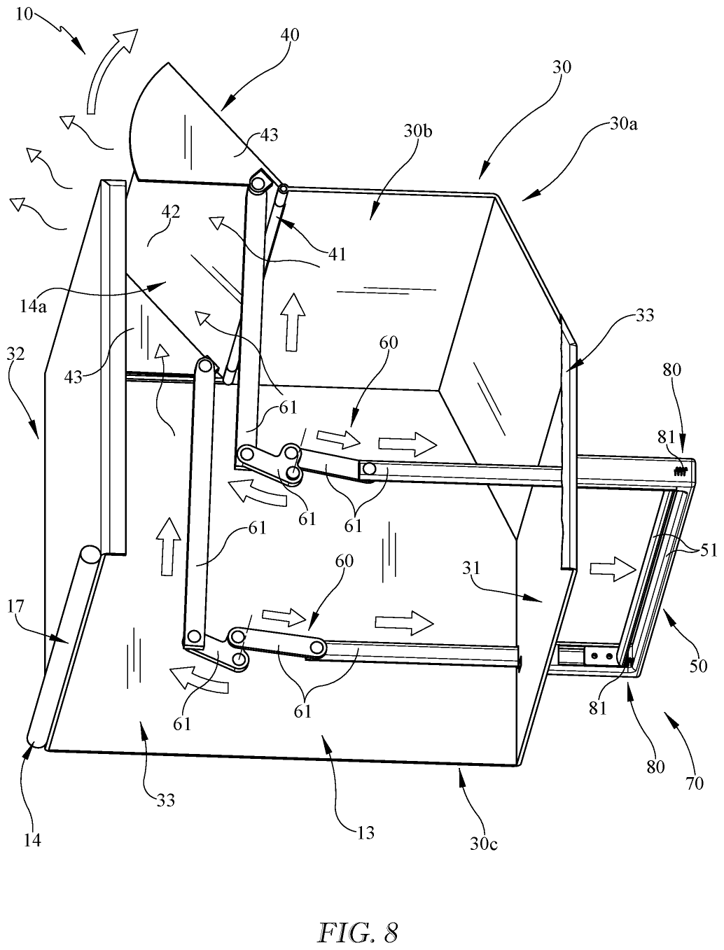

In some implementations, the one or more actuators 70 of the one or more vents 40 may be one or more handles 50. The handle 50 (e.g. movement) may actuate (e.g. open, close, drive) the vent 40 relative to the appliance 10/lid 30/vent opening 14a to one or more positions. The one or more handles 50 may actuate the vent(s) 40 in one or more positions of the lid 30. The user may operate the handle 50 to move/drive the vents 40 in a variety of ways, not limited to pushing and/or pulling. The user may operate the handle 50 to open/close the lid/door 30 relative to the housing 14/appliance 10. As shown in the one embodiment in FIGS. 1-8, the handle 50 may actuate/operate the vent 40 between positions (e.g. closed, open, first, second, etc.). The handle 50 is interconnected to the vent 40 via the articulating assembly 60. In the one embodiment shown, one or more linkage members 61 and/or plungers 63 are used as the articulating assembly 60, 160, however other assembly constructions are contemplated. The handle 50 may be on the front surface/wall 31 of the lid 30, however the handle 50 may be in a variety of positions relative to the vent 40 or lid 30. The vent 40 (e.g. adjacent rear wall of lid, adjacent top wall of lid, appliance) may be positioned opposite to the handle 50 (e.g. front or lid/appliance) in some embodiments. The actuator 70 and/or handle 50 may actuate the vent(s) 40 in the closed position of the lid 30. The actuator 70 and/or handle 50 may actuate the vent(s) 40 in the open position of the lid 30. The actuator 70 and/or handle 50 may actuate the vent(s) 40 in both the one or more closed positions and the one or more open positions of the lid 30 as shown in the one embodiment. Although not shown in the one embodiment in FIGS. 1-8, the handle 50 may actuate in only the open position of the lid 30 or only in the closed position of the lid 30. The handle 50 may include one or more portions/members 51. The one or more portions 51 or handles 50 may be moveable (e.g. pivot, slide, linearly, arcuately, rotatably) relative to each other and/or to the lid 30/appliance 10. The one or more portions 51 of the handle 50 may engage or connect to one or more portions of the articulating assembly 60 and/or vent 40 (e.g. side wall, first wall, wall). The user may actuate at least one portion 51 of the handle 50 to drive/actuate the articulating assembly 60/vent 40. The user may move one or more portions 51 of the handle 50 or actuator 70 between positions when actuating the vent 40. One or more portions 51 of the handle 50 or actuator 70 may be in at least a first position relative to another or remaining portion of the handle 50 or appliance 10/lid 30/actuator 70, or portions thereof, when the vent(s) is in the closed position and at least a second position when the vent(s) 40 is in the open position. For example, as shown in the one embodiment in FIGS. 5-8, the user may pull at least a portion 51 of the handle 50 relative to the lid 30 or remaining portion of handle 50. In the first position as shown in FIGS. 5 and 6, the one or more portions 51 of the handle may be proximate the lid 30 and/or distal from other handle portions 51 and when in the second position as shown in FIGS. 7 and 8 the one or more portions of the handle is distal away from the lid 30 and/or proximate the other handle portions 51 (e.g. remaining portion). Further for example, as shown in the one embodiment in FIGS. 1-4, the user may push at least a portion 51 of the handle 50 relative to the lid 30 or remaining portion of handle 50. In the first position as shown in FIGS. 1 and 2, the one or more portions 51 of the handle 50 may be distal away from the lid 30 and/or other handle portions 51 and when in the second position as shown in FIGS. 3 and 4 the one or more portions 51 of the handle 50 may be proximal the lid 30 and/or handle portions 51 (e.g. remaining portion). The handle 50, or portions thereof, may slide or linearly translate between the one or more positions when opening/closing the vent as shown in the one embodiment. Alternatively, the handle 50, or portions thereof, may move in a variety of ways (e.g. pivoting, rotating) and/or direction(s) (e.g. up, lateral, down). The actuator/handle, or portions thereof, may actuate (e.g. open, close) the vent when the lid is in the open position and/or closed position of the lid. The handle/actuator, or portions thereof, may actuate (e.g. open, close) the vent when the lid is in at least the closed position of the lid in some embodiments.

In some implementations, the actuator 70, handle 50, articulating assembly 60, 160, and/or vent 40 may include one or more bias mechanisms 80, 180. In some embodiments, the vent 40/handle 50/assembly 60, 160, or portions thereof, may return to one or more positions (e.g. closed, first position, open, second position, etc.). The user may release and/or reduce the applied force to the handle 50/actuator 70 to allow the vent 40 to close (e.g. rest, closed position), articulating assembly 60, 160, and/or handle to return to a position (e.g. first, rest). The weight of the vent/articulating assembly/lid/handle may urge the vent to close/position (e.g. at least one) and/or handle/assembly to return and/or to a position (e.g. at least one) in some embodiments, alone or in combination with a bias mechanism, if used. In the embodiments shown in FIGS. 1-8, a bias mechanism 80 (e.g. spring) may urge the handle/vent/articulating assembly to a position (e.g. when the vent is closed or towards the closed position of the vent). The appliance/handle/lid, or portions thereof, may include a bias mechanism urging the actuator, articulating assembly, and/or vent, or portions thereof, towards at least one position (e.g. first, rest, closed, etc.) away from at least one open position. Further, the bias mechanism may keep the vent 40 closed. The bias mechanism 80, 180 may be a spring 81 as shown in the one embodiment. The handle 50 may include the bias mechanism 80/spring 81 in the one embodiment in FIGS. 1-8.

In some implementations, in use the user may actuate one or more handles 50 of the lid 30 to position the one or more vents 40 between the closed position and the open position when the door is in at least one position (e.g. closed, open). The user and/or handle 50 may pivot the one or more vents 40 relative to the lid 30 between the closed position (e.g. pivot) closing the vent opening and the open position (e.g. pivot) opening the vent opening. The user may vent the cooking cavity 13 and/or actuate the vent 40 (e.g. via the handle) before opening the lid to the open position, if desired. However, the actuator and/or handle may operate the vent when the lid is in at least one open position. The user may actuate the one or more handles 50 by pushing (FIGS. 1-4) at least a portion 51 of the one or more handles 50 relative to the lid 30. In some embodiments, the user may actuate the one or more handles 50 by pulling (FIGS. 5-8) at least a portion 51 of the one or more handles 50 relative to the lid 30. Actuating the one or more handles may deploy/move the one or more vents away from the one or more vent openings 14a to the open position. Sliding/moving at least a portion of the handle/actuator relative to the lid or another portion of the handle may actuate the vent and/or articulating assembly.

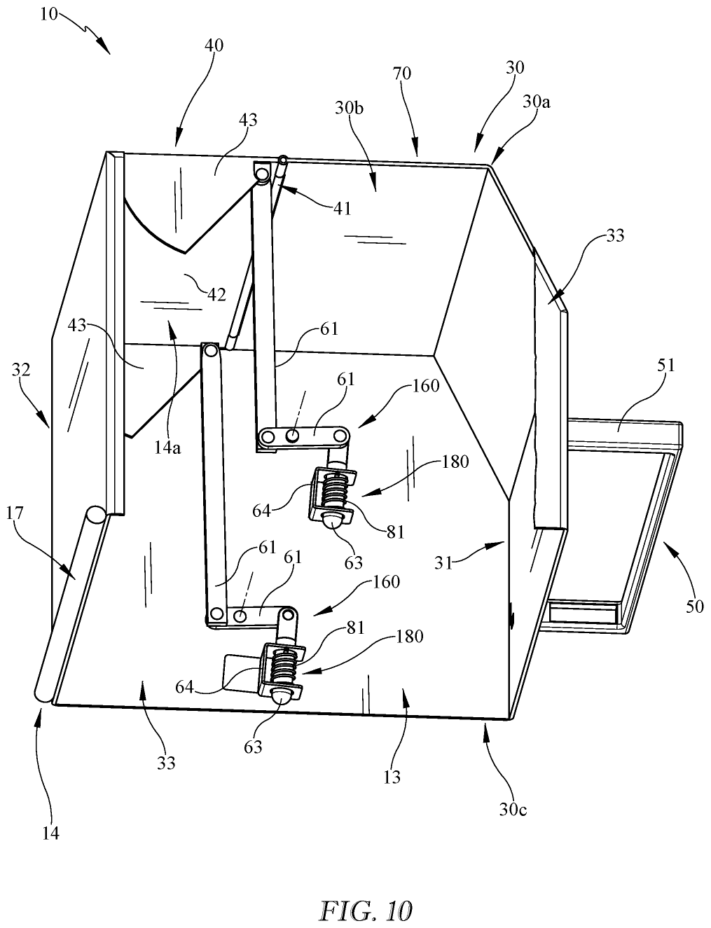

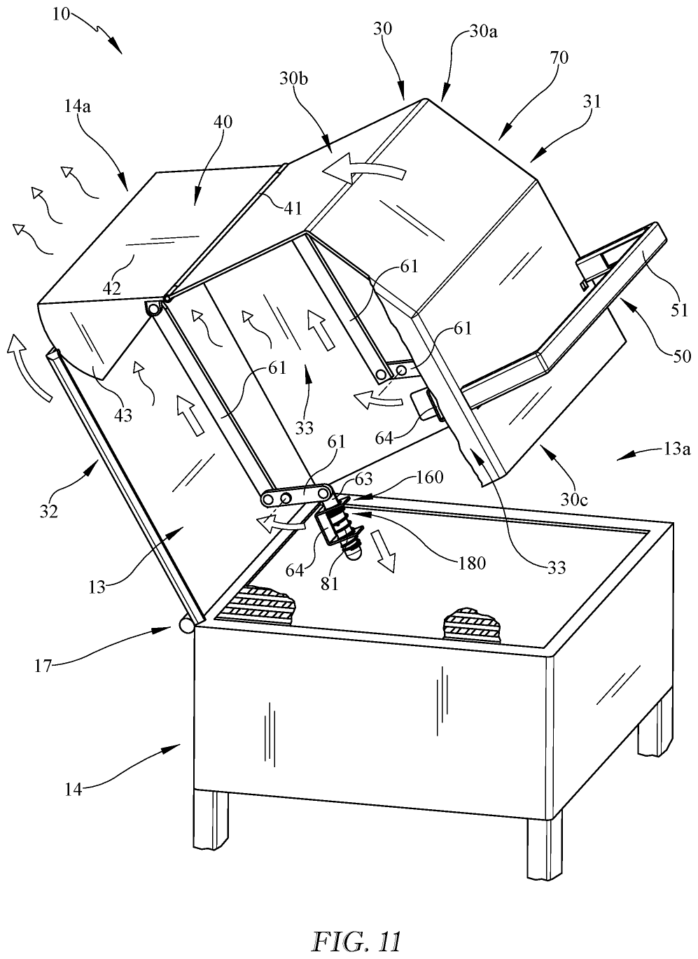

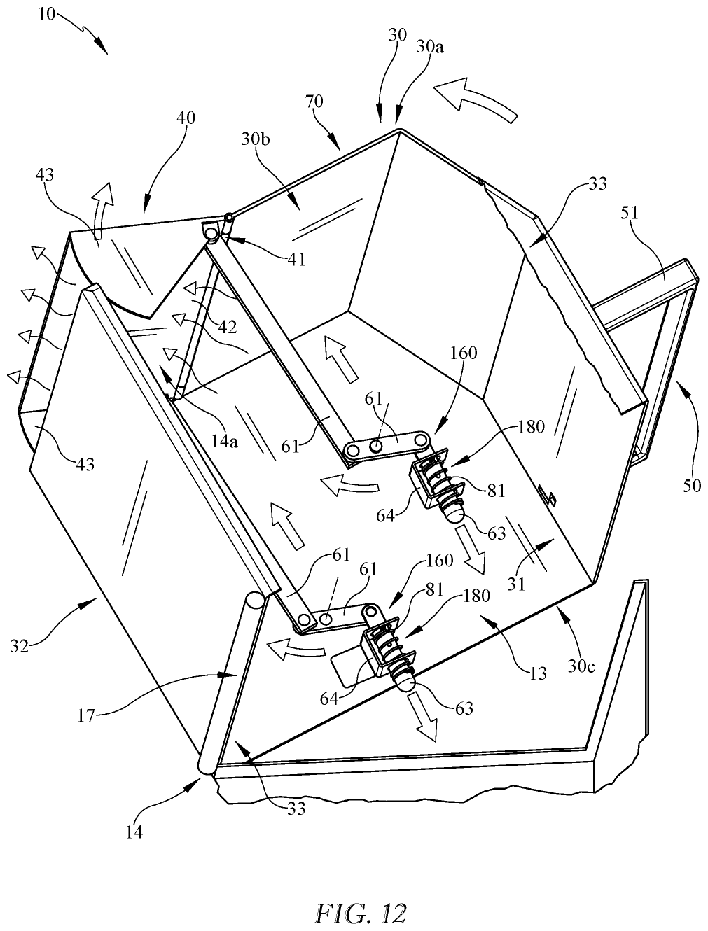

In some implementations, the actuator 70 of the one or more vents 40 may be the lid 30 and/or one or more portions of the appliance 10. The lid 30 (e.g. movement, operation, position, pivoting) may actuate (e.g. open, close) the vent 40 relative to the appliance 10/lid 30/vent opening 14a to one or more positions. The user may operate the lid 30 position to move the vents 40 in a variety of ways not limited to pivoting and/or in one or more movements/directions. The user may operate the lid/handle to open/close the lid/door 30 relative to the housing/appliance. As shown in the one embodiment in FIGS. 9-12, the lid 30 may actuate/operate the vent 40 between positions (e.g. closed, open, first, second, etc.). The lid 30 may be interconnected to the vent 40 via the one or more articulating assemblies 160. In the one embodiment shown in FIGS. 9-12, one or more linkage members 61, bracket(s) 64, and/or one or more plungers 63 (e.g. biased) are used as the articulating assembly 160 although other assemblies are contemplated. The articulating assembly 160 may include the one or more biased plungers 63, bracket 64, and/or linkage members 61 connected to the lid 30 and/or vent(s) 40. The vent 40 (e.g. rear/top of lid/appliance) may be positioned opposite to the handle 50 (e.g. front or lid/appliance) in some embodiments. The actuator 70 or lid 30 may actuate the vent(s) 40 towards the closed position from the open position (e.g. closing the vent opening) when the lid 30 moves towards the closed position of the lid 30 from the open position of the lid 30. The actuator 70 or lid 30 may actuate the vent(s) 40 towards the open position from the closed position (e.g. opening the vent opening) when the lid moves (e.g. away) from the closed position of the lid 30 or remaining portion of the housing 14 to the open position of the lid 30. The lid 30/articulating assembly 160/vent 40 may include one or more bias mechanisms 180. The bias mechanism 180, if used, may urge the one or more vents 40 to or towards the open position as shown in FIGS. 11 and 12. The bias mechanism 180 may be a spring 81 as shown in the one embodiment engaging the plunger 63, linkage member 61, vent 40, and/or bracket 64. The plunger 63 may be positioned/biased (e.g. linearly) between positions (e.g. first, second) depending on the force or lack thereof applied by the portions of the appliance thereto depending on the position of the lid. The bracket 64 may guide the translating pin or plunger 63 and/or spring 81. The spring 81 may surround the plunger/pin 63 and be compressed and/or uncompressed along the axis of the plunger 63. The bias mechanism 180 may urge the linkage members 61 and/or vent 40 towards the open position opening the channel or vent opening 14a. When the lid 30 is closed, the plunger 63 is depressed away from and/or engages the housing compressing the bias mechanism 180 (e.g. spring 81) thereby closing the vent 40 relative to the vent opening 14a via the linkage members 61 and/or assembly 160. When the lid 30 is opened from the closed position in FIGS. 9 and 10, the bias mechanism 180 (e.g. spring 81) urges the plunger 63 from the bracket 64 or away from its depressed position and/or gradually disengages the plunger 63 from the housing 14 and/or reduces the force applied to the plunger 63/spring 81 by the housing 14, thereby opening the vent 40 relative to the vent opening 14a via the linkage members 61 and/or articulating assembly 160.

In some implementations, in use actuating the lid 30 from the closed position to the open position may position the one or more vents from the closed position to the open position. The one or more vents 40 may be biased towards the open position. The one or more vents 40 may be pivoted relative to the lid 30 between the closed position and the open position. The lid 30 may be actuated or operated from the open position to the closed position to position the one or more vents from the open position to the closed position. The lid may 30 be pivoted between a closed position and an open position. The biased plunger 63 may be depressed when the lid 30 is in the closed position or when the lid moves towards the closed position of the lid. The biased plunger may be biased to open the vent via the linkage members and/or articulating assembly in some embodiments when opening the lid.

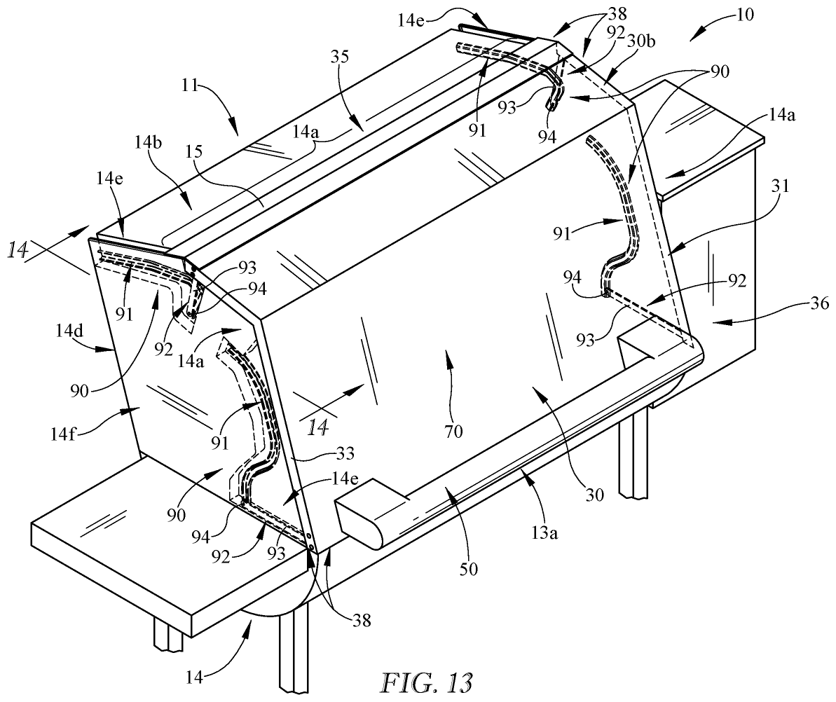

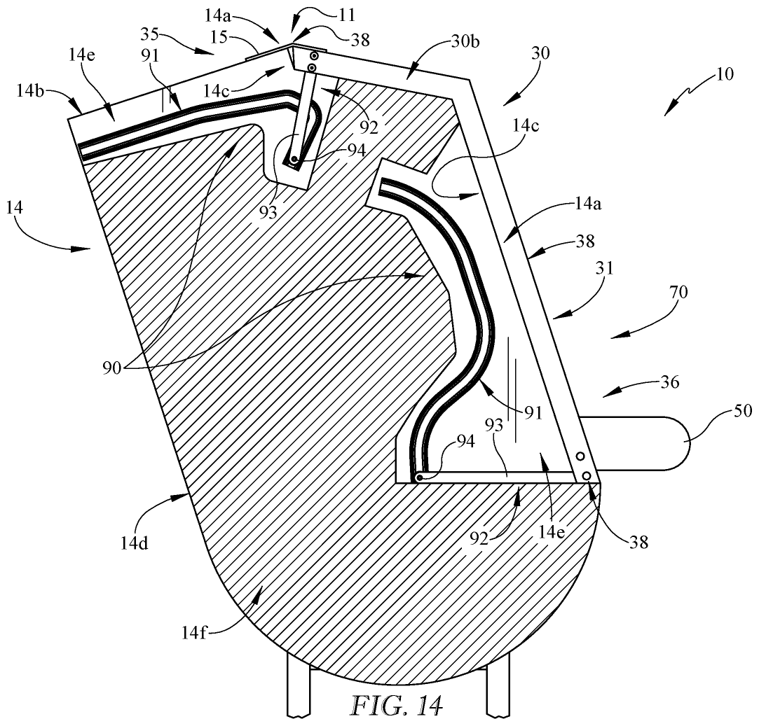

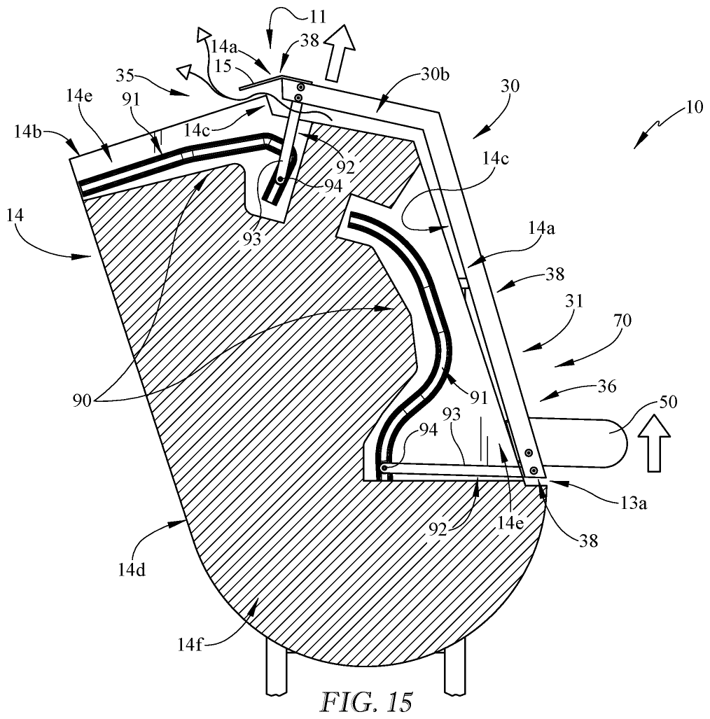

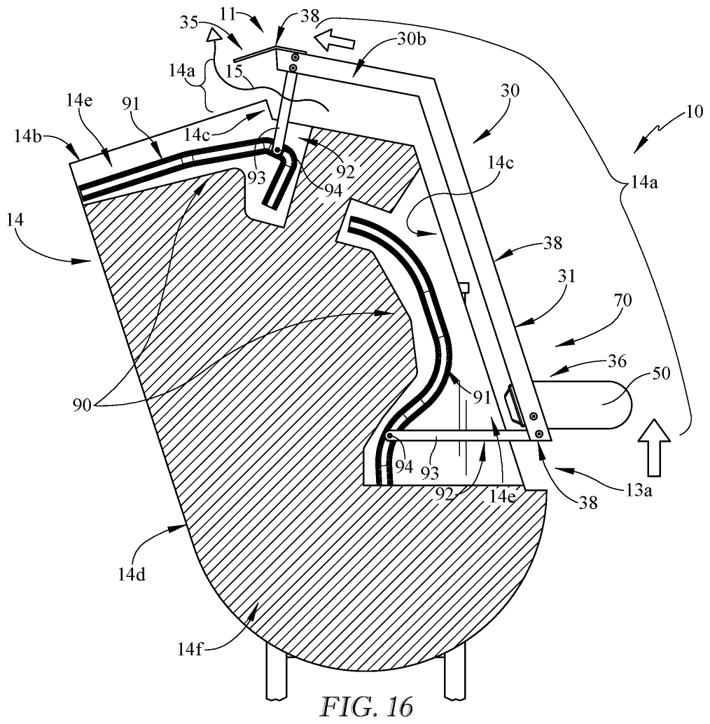

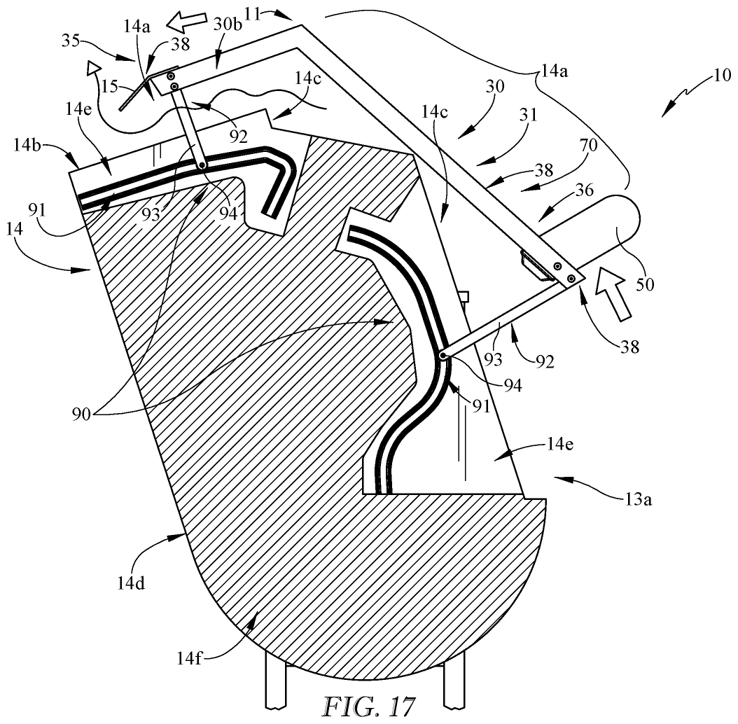

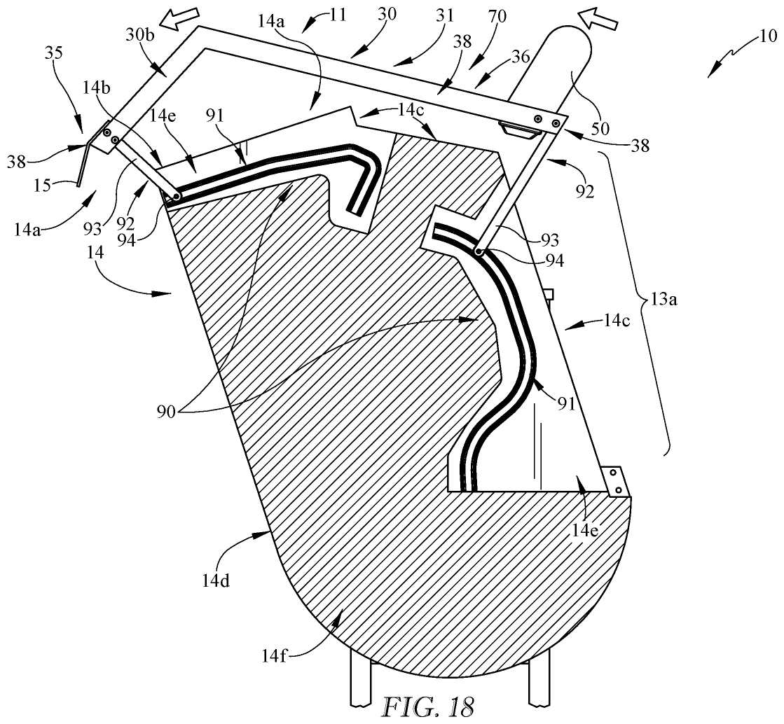

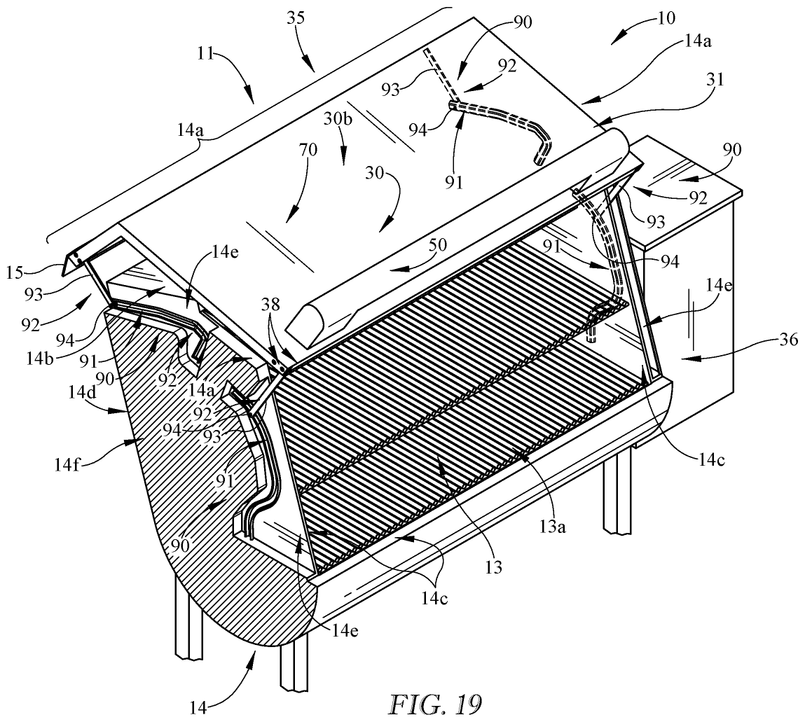

In some implementations, the lid 30 may be a self-venting lid. The actuator 70 may be the operation of the one or more self-venting doors/lids 30. As shown in the one embodiment in FIGS. 13-19, the self-venting lid 30 may be actuated to vent the cooking cavity 13 (e.g. upwardly, away from the front side of the appliance/user). The lid 30 may be actuated (e.g. moveable) between the closed position (FIGS. 13 and 14) and the open position (FIGS. 15-19) different from the closed position to adjust the cooking cavity opening 13a and correspondingly adjust the size/shape of the vent opening 14a (e.g. closed, open). The lid 30 may be adjacent the cooking cavity opening 13a to the housing 14. The lid(s) 30 (e.g. top wall, flange) may define the one or more vent openings 14a with at least a portion of the housing 14 (e.g. top wall, one or more walls/edges/surfaces defining the cavity opening 13a/housing 14). When the lid 30 is in the closed position, the vent opening(s) 14a may be closed between the lid 30 and the housing 14, or portions thereof, (e.g. top wall 30b). When the lid 30 is in the open position, the vent opening(s) 14a may be open between the lid 30 and the housing 14, or portions thereof, (e.g. top wall 30b). When the lid 30 is moved away from the closed position, the closed vent opening 14a opens and/or increases in size and/or shape. When the lid 30 is moved away from the open position towards the closed position, the open vent opening 14a closes and/or decreases in size and/or shape. The one or more vent openings 14a may be defined by at least a portion of the outer periphery 38 of the lid(s) 30 (e.g. top wall 30b, side wall(s) 33, front wall 31) and/or at least a portion of the housing 14 (e.g. top wall 14b, side wall 14f, periphery 14c defining the cavity opening 13a). As shown in the one embodiment in FIGS. 13-19, at least the outer periphery 38 of the lid 30 or lid top wall 30b (e.g. rear portion 35) may define at least a portion of the vent opening 14a relative to the top wall 14b (e.g. periphery 14c) of the housing 14. As shown in FIGS. 13 and 14, the lid 30 (e.g. top wall/edge) may engage the top wall 14b of the housing 14 when in the closed position (e.g. closing the vent opening 14a at the top side 11 of the appliance 10). As shown in FIGS. 15-19, the lid 30 (e.g. top wall/edge) may be disengaged from the top wall 14b of the housing 14 when in the open position (e.g. opening the vent opening 14a at the top side of the appliance). Further shown in the one embodiment, when the lid 30 is in the closed position the entire outer periphery 38 of the lid may be adjacent the housing 14 (e.g. periphery 14c defining the cavity opening 13a) and/or closes the vent opening(s) 14a. When the lid 30 is in the open position the entire outer periphery 38 of the lid 30 may be spaced from the housing 14 (e.g. periphery defining the cavity opening) and/or opens the vent opening(s) 14a. Although the entire periphery 38 of the lid may define the vent opening(s) 14a, one or more portions of the periphery 38 of the lid 30 may define the one or more vent openings 14a. As shown in the one embodiment in FIGS. 13-19, the lid 30, top wall 30b of the lid 30 (e.g. outer periphery 38, top side 11 of the appliance), flange 15 may engage/disengage from the top wall 14b of the housing 14 (e.g. cavity periphery) to open/close at least one vent opening(s) 14a (e.g. top vent opening, upper vent opening, opposing cavity opening). The vent opening(s) (e.g. top, upper) between the top wall of the housing and lid (e.g. top wall or rear edge/wall) may be adjacent the top side of the appliance/grill. The top vent opening size may be opened the same as or different (e.g. faster, varying rates) than other vent openings, if used, surrounding the lid periphery.

In some implementations, the top wall/side 11 of the appliance 10 may be defined by the top wall 14b of the housing 14 and the top wall 30b and/or rear edge/portion 35 of the lid 30. The top wall/side 11 of the appliance 10 or top walls 14b, 30b of the housing 14 and lid 30 may define the vent opening(s) 14a adjacent the top side 11 of the appliance. As shown in FIG. 13-19, the lid 30 (e.g. top wall) may move or travel upwardly and/or towards the user when moved/actuated away from the closed position of the lid/vent opening towards the open position of the lid/vent opening. Other movements and direction of the lid are contemplated. The vented cavity gases/heat may be vented upwardly and/or away from the user through the vent opening(s) 14s (e.g. top vent opening) defined by the top wall/side of the appliance/housing/lid. The top vent opening may be opened within the top wall concurrently with the cavity opening (e.g. front) with the lid actuating as shown in the one embodiment, although the top vent opening may be opened before the front cavity opening is opened in some embodiments. In some embodiments, gases, etc. may be vented from other vent openings rather than only the top vent opening.

In some implementations, the appliance 10 (e.g. outdoor grill) and/or lid 30 may include one or more articulating assemblies or engagements 90 with the housing 14 to self-vent and/or move the lid 30 relative to the cavity 13/opening 13a/housing 14 when being actuated between positions. The lid 30 or engagement(s) 90 may slidably engage the housing 14 between positions. The sliding engagement 90 may allow the lid 30 and/or followers 92 (e.g. member 93, pin 94) to pivot along the one or more tracks. Lid and/or followers may pivot about the moving axis of the pins. The sliding engagement may be described as not having a fixed pivot or hinge engagement (e.g. stationary) as shown in FIGS. 1-12. The sliding engagement/path may be the same between the open position and the closed position as shown in the one embodiment in FIGS. 13-19. Alternatively, the paths/engagements may be different. The sliding engagement 90 (e.g. pin and slot) between the lid 30 and the housing 14 may include one or more followers 92 and one or more tracks 91. The one or more followers 92 may engage (e.g. slidably) the one or more tracks 91 to guide the one or more followers 92 (e.g. pin, member) and/or lid(s) 30 between positions, or between the closed position and the open position. The one or more followers 92 may slidably engage the one or more tracks 91 between the housing 14 and the lid 30. Alternatively in some embodiments, the engagement 90 may be a four bar linkage system or 6 bar linkage system. In some embodiments now shown, the engagement 90 may include a soft open device and/or a soft close device that may be used with or in the track 91 engaging with the followers 92. For example, the device may be a damper and/or spring system. In the one embodiment shown in FIGS. 13-19, the housing 14 may include the one or more tracks 91 and the lid 30 may include the one or more followers 92. The housing 14 may include a top wall 30b, rear wall 14d (e.g. depending from the top wall), and side wall(s) 14f (e.g. depending from the top wall). The rear wall 14d may connect to the side walls 14f and the top wall 14b. The periphery 14c of the top wall 14b and side walls 14f may define at least a portion of the cavity 13/opening 13a. The cavity 13/housing 14 may include a grill(s)/rack(s). The one or more tracks 91 may be positioned on or adjacent the one or more side walls 14f, or more specifically the interior surface or slots 14e of the side walls 14f and/or top wall 14b as shown in the one embodiment. The one or more tracks may run from the top side towards the bottom side of the appliance and/or along the length of the side wall and/or depending from the top wall 14b of the housing 14. The slot openings may be adjacent the housing top wall or top side of the appliance and/or the housing side wall or front side of the appliance. The one or more followers 92 may project from the lid 30 (e.g. inner surface, slot(s)). The followers 92 may project inwardly into the cavity or housing 14 (e.g. slots) when the lid 30 is in at least the closed position and may partially project from the housing (e.g. slots) or cavity when the lid 30 is in the open position. The one or more followers may inwardly project from the top wall 30b of the lid 30 and/or the front wall 31 of the lid 30. The one or more followers 92 may be adjacent the outer periphery 38 of the lid 30. The one or more followers 92 may be fixed relative to the lid 30. The one or more followers 92 may be at least one member 93 projecting from the lid 30 and/or at least one pin 94. The pin 94 may be positioned on the distal end of the member 93 away from the lid 30. The one or more pins 94 may slidably engage the one or more tracks 91. As shown in the one embodiment, a rear portion 35 and/or top wall 30b of the lid 30 may include a first set of one or more followers 92 (e.g. member(s), pin(s)) slidably engaging one or more tracks 91 (e.g. between the housing and the lid) and a front portion 36 and/or front wall 31 of the lid 30 may include a second set of one or more followers 92 (e.g. member(s), pin(s)) slidably engaging one or more tracks 91 (e.g. between the housing and the lid). Stated alternatively, a pair of followers, a rear follower (e.g. adjacent the rear portion 35 of lid) and a front follower (e.g. adjacent the front portion 36 of the lid), may be positioned adjacent the housing side wall 14f and/or lid side wall 33/outer periphery 38. Alternatively, the housing 14 may include one or more followers 92 and the lid 30 may include one or more tracks 91. Further, the housing 14 may include a combination of tracks and followers and the lid 30 may include a combination of tracks and followers. The one or more followers 92 may slidably engage the one or more tracks 91 when venting, moving/actuating the lid (e.g. closing, opening), and/or adjusting the vent opening 14a (e.g. closing, opening).

In some implementations, the track and follower may be a variety of shapes, quantities, sizes, positions, and constructions and still be within the scope of the invention. For example, the track 91 may be non-linear or move the lid relative to the housing in a non-linear path. The track 91 may be arcuate in shape. The track may be shown as two separate tracks or sections on each side wall 14f of the housing 14, however one track may be used on both side walls in some embodiments. Further, although the track/follower engagement 90 is shown on each lateral side of the lid/housing, it is understood that a single track/follower engagement may be used. Further, the pins 94 may be or include rollers. Although the members or followers extend/pass/slide/project through slots 14e, if used, (e.g. separate, single) in the top wall 14b and/or side wall 14f of the housing 14 when the lid travels between the closed position and the open position, the housing may not include slots in some embodiments.

In some implementations, the appliance 10, lid 30, and/or housing 14 may include one or more flanges 15. The one or flanges 15, if used, may be positioned adjacent at least a portion of the outer periphery 38, 14c of the lid/housing 30/14. The flange 15 may be positioned adjacent the engagement between the housing and lid when the lid is in the closed position. The one or more flanges are shown as projecting from the lid (e.g. top wall, rear portion). The one or more flanges 15 may overlap or releasably engage the top wall 14b (e.g. exterior surface) of the housing 14. The flange may extend or project from the rear portion 35 and/or top wall 30b of the lid 30. The flange 15 may project over (e.g. abut) the top wall 14b (e.g. front edge, periphery 14c) of the housing 14 when in the closed position and/or the abutment between the lid and the housing when in the closed position. The flange 15 may not overlap the housing when in the open position in some embodiments. Although a single flange 15 may be adjacent only along the rear portion 35 of the lid top wall 30b as shown in the one embodiment, the flange(s) may be of a variety of positions, lengths, sizes, shapes, quantities, and constructions along the periphery of the lid or the housing.

In some implementations, in use the grill or cooking appliance 10 may be self-venting when operating/actuating the lid 30. The cooking appliance 10 may include the top side or end 11 having the top wall 14b of the housing 14 and a portion of the lid 30 (e.g. top wall 30b). The user actuates the lid 30 relative to the housing from the closed position towards the open position. This actuation of the lid 30 may manipulate (e.g. size, shape) the opening 13a to the cooking cavity 13 and/or vent openings 14a surrounding one or more portions of the lid periphery 38. When opening the lid, the cooking cavity 13 may upwardly vent from the top side 11 of the appliance 10 or vent opening 14a (e.g. top, upper) between the top wall 14b of the housing 14 and the lid 30 (e.g. portion(s), top wall 30b, rear portion 35, flange 15). The vent opening 14a (e.g. between the lid top wall/rear portion and the housing top wall/front edge) may increase in size and/or shape when opening the lid. In addition, in some embodiments when opening the lid 30, one or more vent openings 14a adjacent the lateral sides and/or front portion of the lid (e.g. adjacent the opposing housing side walls, front side of the housing) may be opened from the closed position. When opening/moving the lid 30 away from the closed position towards the open position, the lid 30 (e.g. top wall, rear portion, flange) may travel (e.g. initially) upwardly and/or towards the user or front side of the appliance and/or away from the housing (e.g. top wall, front edge). Alternatively stated, the rear portion 35 of the lid may pop/rise upwardly and/or away from the housing (e.g. top wall), front portion 36 of the lid 30, and/or remaining portion of the appliance 10. When opening the lid 30, the opening 13a adjacent the front portion 36 or handle 50 of the lid 30 may be minimal or reduced as compared to a pivoting lid 30 and/or the to the top side vent opening 14a of the one embodiment as shown in FIGS. 13-19. The lid 30 may slidable engage (e.g. one or more sliding engagements 90) the housing between the closed position and the open position. The lid 30 may slide relative to the housing in a non-linear path. The lid may slide in a non-pivoting path about a fixed hinge. The lid may travel in a variety of directions along one or more accurate paths defined by the one or more tracks 91.

While several embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It is to be understood that the embodiments are not limited in its application to the details of construction and the arrangement of components set forth in the description or illustrated in the drawings. The invention is capable of other embodiments and of being practiced or of being carried out in various ways. Unless limited otherwise, the terms “connected,” “coupled,” “in communication with,” and “mounted,” and variations thereof herein are used broadly and encompass direct and indirect connections, couplings, and mountings. In addition, the terms “connected” and “coupled” and variations thereof are not restricted to physical or mechanical connections or couplings.

The foregoing description of several embodiments of the invention has been presented for purposes of illustration. It is not intended to be exhaustive or to limit the invention to the precise steps and/or forms disclosed, and obviously many modifications and variations are possible in light of the above teaching.

1. An appliance having a cooking cavity comprising:
a housing having the cooking cavity and defining an opening into the cooking cavity;
a lid hingedly attached adjacent the opening into the cooking cavity to the housing, and wherein the lid is positionable between a closed position and an open position relative to the opening into the cooking cavity, and wherein the lid defines at least one vent opening; and
wherein the lid includes one or more vents;
wherein the one or more vents are moveable between a closed position closing the at least one vent opening to define a portion of the cooking cavity and an open position different from the closed position; and
wherein the lid actuates the one or more vents between the closed position and the open position.

2. The appliance of claim 1 wherein when the lid moves from the closed position to the open position, the one or more vents move from the closed position to the open position.

3. The appliance of claim 1 wherein when the lid moves from the open position to the closed position, the one or more vents move from the open position to the closed position.

4. The appliance of claim 1 wherein the one or more vents is adjacent a rear wall of the lid.

5. The appliance of claim 1 further comprising an articulating assembly connected to the one or more vents of the lid.

6. The appliance of claim 5 wherein the articulating assembly includes one or more linkage members and/or at least one biased plunger connected to the one or more vents.

7. The appliance of claim 6 wherein the articulating assembly includes the at least one biased plunger.

8. The appliance of claim 1 further comprising a bias mechanism urging the one or more vents to the open position.

9. A lid hingedly attached to an appliance and positionable between a closed position and an open position, the lid comprising:
one or more vents positionable between a closed position closing one or more vent openings defined by at least a portion of the lid when the lid is in the closed position and an open position opening the one or more vent openings defined by at least the portion the lid when the lid is in the open position; and
one or more bias mechanisms urging the one or more vents to the open position.

10. The lid of claim 9 wherein the lid actuates the one or more vents between the closed position and the open position.

11. The lid of claim 10 wherein when the lid moves from the closed position to the open position, the one or more vents move from the closed position to the open position.

12. The lid of claim 9 wherein the bias mechanism includes at least one biased plunger.

13. The lid of claim 9 wherein the bias mechanism is connected to the one or more vents via one or more linkage members.

14. The lid of claim 9 wherein the one or more vents include a first wall and one or more depending walls extending from the first wall.

15. A method of articulating one or more vents of a cooking appliance comprising the steps of:
providing a housing having a cooking cavity defining an opening into the cooking cavity and a lid hingedly attached adjacent the opening into the cooking cavity to the housing, and wherein the lid is positionable between a closed position and an open position relative to the opening into the cooking cavity, and wherein the lid includes one or more vents positionable between a closed position closing at least one vent opening and an open position different from the closed position; and
actuating the lid from the closed position to the open position to position the one or more vents from the closed position to the open position.

16. The method of claim 15 further comprising biasing the one or more vents towards the open position.

17. The method of claim 15 further comprising pivoting the one or more vents relative to the lid between the closed position and the open position.

18. The method of claim 15 further comprising actuating the lid from the open position to the closed position to position the one or more vents from the open position to the closed position.

19. The method of claim 15 further comprising pivoting the lid between the closed position and the open position.

20. The method of claim 15 depressing a biased plunger when the lid is in the closed position.
